(19) United States
(12) Patent Application Publication
(10) Pub. No.: US 2006/0195492 A1
(43) Pub. Date: Aug. 31, 2006

(54) Method and apparatus for implementing an adaptive data warehouse

(75) Inventors: Allen I. Clark, Woodinville, WA (US); Bryan MacFarlane, Duvall, WA (US); Xiongjian Fu, Sammamish, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/067,285

(22) Filed: Feb. 25, 2005

(51) Int. Cl. G06F 17/30

(52) U.S. Cl. 707/204

(57) ABSTRACT

In one embodiment, a method an apparatus for managing a system comprising at least one operational data store and a data warehouse that is associated with at least some of the data in the operational data set, comprising automatically updating the schema of the data warehouse to reflect a change to the schema of the at least one operational data store. In a further embodiment, a method and apparatus for requiring that a designer of a database system provide metadata that defines changes to be made to a data warehouse in response to a modification of an area in an operational store. In another embodiment, a method and apparatus for detecting schema changes to an operational store, so that appropriate action may be taken in a data warehouse. In a further embodiment, a method and apparatus for implementing changes to a data warehouse schema, comprising the execution of one or more lower level calls to appropriate APIs to modify the schemas of both a relational database and an OLAP database.

### FIELD OF INVENTION

The present invention relates to adaptive data warehouse architectures.

### BACKGROUND OF INVENTION

Businesses often deal with large amounts of data essential for daily operation (e.g., databases). Data necessary for this daily operation is typically stored in operational stores that serve the functions of data processing and support of business operations. Operational stores contain current data which is process oriented and highly detailed. For example, an operational store might contain a database organized around business activities or functional areas (e.g., order processing and manufacturing). An enterprise might utilize multiple operational stores dedicated to different activities, resulting in identical data being stored in multiple locations. Operational stores are ideally suited to serve the purposes of daily business activities, but are deficient from the view point of decision support.

To support analysis and decision making, computer systems may also include a data warehouse in addition to an operational store. A data warehouse is organized around subject matter, which is highly suited to decision support. Data warehouses are time variant, and contain both historical and current data. Typically, data warehouses are populated by transforming data stored in operational stores. In particular, current data in operational stores is appended to a data warehouse on a periodic basis, enabling the data warehouse to store historical data values.

### SUMMARY OF INVENTION

One illustrative embodiment of the invention is directed to a method for managing a system comprising at least one operational data store that stores an operational data set and a data warehouse that stores a warehouse data set that is associated with at least some of the data in the operational data set, each of the at least one operational data store and the data warehouse having a schema. The method comprising an act of, in response to a change being made to the schema of the at least one operational data store: (A) automatically updating the schema of the data warehouse to reflect the change to the schema of the at least one operational data store.

Another illustrative embodiment of the invention is directed to a computer-readable medium having instructions encoded thereon, which instructions, when executed in a computer system perform a method for managing a system comprising at least one operational data store that stores an operational data set and a data warehouse that stores a warehouse data set that is associated with at least some of the data in the operational data set, each of the at least one operational data store and the data warehouse having a schema. The instructions, when executed in the computer system, perform the method comprising an act of, in response to a change being made to the schema of the at least one operational data store: (A) automatically updating the schema of the data warehouse to reflect the change to the schema of the at least one operational data store.

### BRIEF DESCRIPTION OF DRAWINGS

In the drawings, each identical or nearly identical component that is illustrated in various figures is represented by a like numeral. For purposes of clarity, not every component may be labeled in every drawing. In the drawings:

FIG. 1 is a block diagram of a prior art system comprising a data warehouse, an operational store, and a database transformation service;

FIG. 2 is a block diagram showing a system comprising a data warehouse, an operational store, and a warehouse service in accordance with one embodiment of the invention;

FIG. 3 is a flow chart showing a process for storing information defining a schema change to a data warehouse in response to a schema change of an operational store in accordance with one embodiment of the invention; and

FIG. 4 is a flow chart showing an exemplary process for detecting schema changes in an operational store and modifying an associated data warehouse schema in accordance with one embodiment of the invention.

### DETAILED DESCRIPTION

As described above, data from an operational store may be transformed and loaded into an associated data warehouse. Typical data warehouses are static in nature, meaning that they draw data from a set of one or more operational stores. When the schema of one or more of those operational stores changes, the service that transforms the data and places it in the data warehouse in conventional systems must be manually modified to account for the schema change of the operational stores.

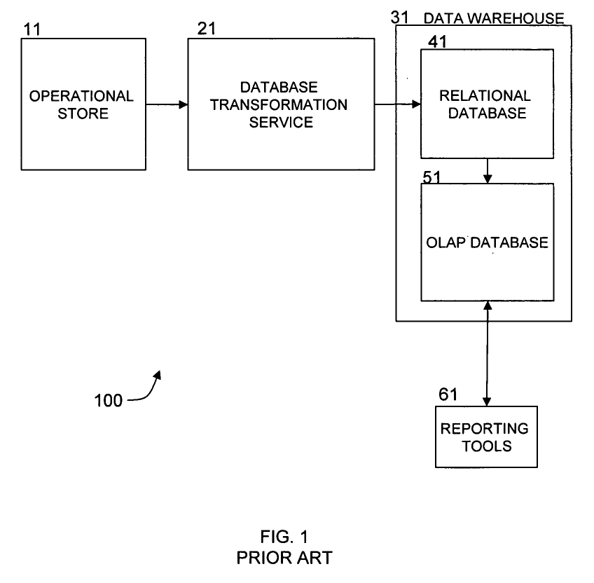

FIG. 1 illustrates a conventional system 100 comprising a data warehouse 31 which contains data originating from an operational store 11. The operational store 11 comprises data organized around business activities or functional areas. For example, the operational store 11 may comprise a transaction database, a delivery database, and any other operationally related database. For example, in an operational store 11 comprising a delivery database, data entries may include a customer list with detailed information on customer addresses indexed by customer number. Furthermore, the data in an operational store 11 typically only comprises current values with very little historical information. For example, in an operational store 11 comprising a delivery database, the customer list typically only contains the most current customer addresses.

By contrast, the data warehouse 31, which may comprise a relational database 41 and an online analytical processing (OLAP) database 51, is organized around subjects. For example, the subjects could be products, customers, sales, or any other subject. The relational database 41 is a collection of data items organized as a set of tables with each table organized into columns and rows. One or more data categories may be provided in columns, with each row containing a unique instance of data for the categories laid out in the columns. For example, the relational database 41 may contain a table describing customers, with columns for name, address, telephone number, etc., where each row of the table contains a unique instance of a customer. Similarly, a table describing orders may include columns for product, customer, date, price, etc.

By contrast, the OLAP database 51, which is typically built from data in the relational database 41, comprises one or more multi-dimensional databases, sometimes referred to as cubes. Each dimension of the multi-dimensional databases comprises a data attribute, for example, product, geographic sales regions, time period, etc. The OLAP database 51 may contain some or all of the data present in the relational database 41, and the data contained in the OLAP database 51 may be imported from the relational database 41.

The OLAP database 51 allows a user to easily extract and analyze data from different view points. For example, a user may utilize reporting tools 61 to issue queries that summarize data in various ways. For example, a query might request the total sales revenue and quantity sold for a number of products for a specific time period and in a specific geographic region. The reporting tools 61 may comprise tools that operate according to the Structured Query Language (SQL), a spreadsheet, or other reporting tools.

The system 100 also comprises a database transformation service 21, which extracts, transforms, and consolidates data from the operational store 11 to the relational database 41. The database transformation service 21 performs one or more functions or operations that are applied against data from a source, for example, the operational store 11, to transform and consolidate the data to the relational database 40. Examples of possible transformations include selecting data from the data source, mapping the columns of the data based on a set of transformations, and sending the transformed data to the destination. For example, in the aforementioned system 100, the destination is the relational database 41 of the database warehouse 31, and the data source includes the operational store 11.

Applicants have appreciated that in some systems, the operational store 11 may undergo a change in schema (i.e., a change in the organization or structure of the database) in response to administrative settings made by a user or administrator of the operational store 11. If a data warehouse 31 were to continue to draw from the operational store 11 in the same manner, the changes would not be reflected in the data warehouse 31. As a result, any newly added data would not be available in the data warehouse 31. Thus, in many cases the data transformation service 21 that draws data from the operational store and exports the data to the data warehouse 31 would no longer be fully valid after the schema change to the operational store 11.

In accordance with one embodiment of the invention, an adaptive data warehouse architecture is employed that provides the ability to build a data warehouse that can respond automatically to schema changes in an associated operational store. The adaptive data warehouse architecture can achieve the aforementioned in any of numerous ways, as the invention is not limited to any particular implementation technique. In one illustrative embodiment, metadata is provided which describes a desired schema change to a data warehouse in response to a schema change of an operational store. As a result, a change in the schema of the operational store can automatically result in the schema change of the data warehouse.

In the conventional system 100, a schema change in the operational store 11 requires that a programmer manually change the data transformation service 21 and the schema of the data warehouse 31 to enable the data warehouse 31 to reflect the operational store 11 schema changes. For example, adding, removing, or renaming fields in the operational store 11 requires that the data transformation service 21 and the data warehouse 31 schema be manually modified. For example, adding a field to the operational store 11 may require that a field be manually added to the tables in the relational database 41 using calls to one or more application program interfaces (API) (e.g., in the SQL language or any other) that enable manipulation of the relational database 41. In addition, a dimension may need to be manually added to the cubes in the OLAP database 51 by performing similar calls to one or more APIs (e.g., in the SQL language or any other). Finally, as mentioned previously, the data transformation service 21 must be manually modified by a programmer to reflect the schema changes in the operational store 11, thereby allowing the appropriate transformation of data from the operational store 11 to the data warehouse 31.

Applicants have appreciated that this conventional technique has some serious deficiencies, since it requires a substantial amount of manual modifications to ensure valid transformation of data to the data warehouse. Applicants have realized that an adaptive warehouse architecture may alleviate some or all of the aforementioned deficiencies, by automatically detecting changes of the operational store schema and modifying the schema of the data warehouse.

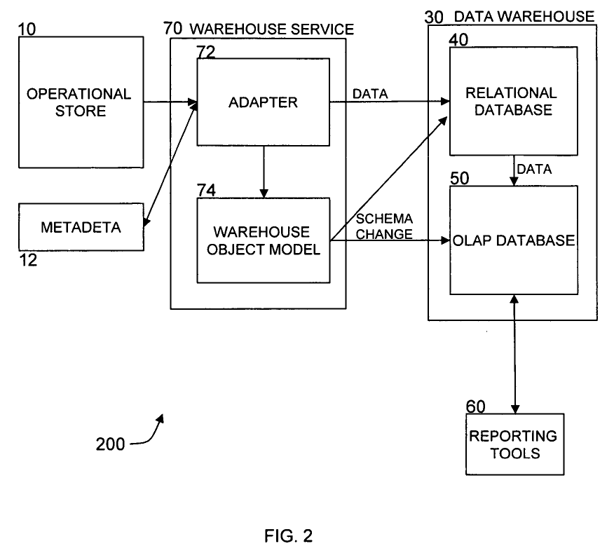

FIG. 2 illustrates an exemplary system 200 implementing an adaptive warehouse architecture in accordance with one embodiment of the invention, that enables the detection of changes to an operational store 10 schema and modification of a data warehouse 30 schema in response to the detected changes. System 200 includes the operational store 10, the data warehouse 30 (comprising a relational database 40 and an OLAP database 50), and reporting tools 60. In the embodiment shown, the system 200 does not include a data transformation service 20 (although alternate embodiments can be implemented with a data transformation service). Rather, system 200 comprises a warehouse service 70, comprising an adapter 72 and a warehouse object model 74, which transforms data from the operational store 10 to the data warehouse 30.

In system 200, the relational database 40 and OLAP database 50 are supported by the warehouse service 70, which manages and coordinates the flow of data from the operational store 10 into the data warehouse 30, the processing of cubes in the OLAP database 50, and the changes to the schema of the data warehouse 30.

Data from the operational store 10 may be incorporated into the data warehouse 30 in any suitable manner, as the invention is not limited in this respect. In one embodiment, this may be performed by providing an initial schema definition that describes facts, dimensions, measures, and factlinks, and which may be implemented using the Extensible Markup Language (XML) or any other suitable language. The data warehouse service 70 may interpret the initial schema definition and then create the corresponding relational database 40 and OLAP database 50 objects (e.g., tables and cubes). The adapter 72 may then transform the data from the operational store 10 and load the transformed data into the data warehouse 30. For example, the adapter 72 may load the data into the relational database 40, and data from the relational database 40 may then be loaded into the OLAP database 50 by any suitable service (not shown). Alternatively, the adapter 72 may load the data into both the relational database 40 and the OLAP database 50.

In cases where the operational store 10 schema is subject to modification, schema changes may be detected in any suitable way, as the invention is not limited to any particular implementation technique. In one embodiment, the adapter 72 may detect changes to the operational store 10 schema in any suitable way. In another embodiment, the adapter 72 may detect changes in the operational store 10 schema based on date and time stamp information contained in metadata 12. For instance, an operational store 10 schema change may be detected when any operational store 10 schema data in metadata 12 possesses a date and time stamp that is more recent than a previous date and time when the warehouse service 70 updated the data warehouse 30 schema. This is just an example, as the invention is not limited to this our any other implementation technique.

As a result of any detected operational store 10 schema changes, appropriate changes to the data warehouse 30 can be automatically made in any suitable way, as the invention is not limited in this respect. In one embodiment, the adapter 72 may call the warehouse object model 74 when a schema change in the operational store 10 is detected. The warehouse object model 74 may then call appropriate APIs to perform the desired schema changes in the data warehouse 30 based on schema change information contained in the metadata 12. The schema change information in the metadata 12 may indicate the desired data warehouse 30 schema change for a given operational store 10 schema change. The metadata 12 may also be updated or modified (e.g., by the adapter 72 or otherwise) for purposes of recording any changes to the operational store 10 and/or data warehouse 30 or for any other suitable reason. For example, if a name of a field in the operational store 10 and the data warehouse 30 was renamed the previous name may be recorded in the metadata 12.

In the embodiment described above, system 200 is adaptable, meaning that schema changes in the operational store 10 are automatically reflected in the data warehouse 30. Furthermore, although the illustration in FIG. 2 shows only one operational store 10, a plurality of operational stores 10 may also be present, where each of the operational stores 10 may possess a dedicated adapter 72, or may share an adapter 72, as the invention is not limited to any particular implementation. When a plurality of adapters 72 are employed, each adapter 72 may in turn call a dedicated warehouse object model 74 or all may call the same warehouse object model 74, as the invention is not limited in this respect.

The metadata 12 may be stored in the operational store 10 or in any suitable location. The metadata 12 may be coded using XML or any other suitable language, and may include information regarding the schema change desired in the data warehouse 30 as a result of a schema change in the operational store 10.

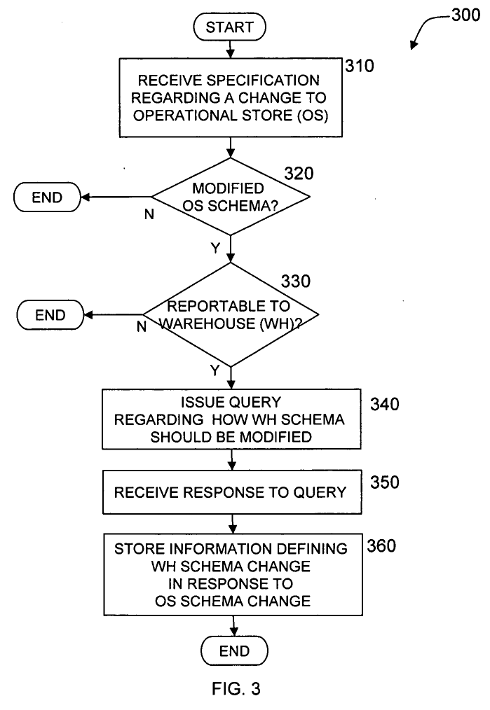

In accordance with one embodiment, the metadata 12 may be at least partially populated based on a query, and a response, from a designer of the data warehouse 30. In such an embodiment, the designer may provide the information to specify how schema changes in the operational store 10 translate to schema changes in the data warehouse 30, as shown in the process 300 depicted in FIG. 3.

The process 300 of FIG. 3 begins with act 310 when a specification is received regarding a change to the operational store 10. In one embodiment, the designer may specify the change to the operational store 10 by providing input to a user interface (UI). The UI can take any suitable form (e.g., a graphical interface, a command line, or any other input mechanism) as the invention is not limited to any particular user interface. A change that modifies the schema of the operational store 10 may include any changes (e.g., adding, removing or editing) to facts, dimensions, measures and/or factlinks associated with the operational store 10. For example, any of adding, removing or renaming a field in the operational store 10 may qualify as a schema change of the operational store 10.

The process 300 then proceeds to act 320, wherein a determination is made as to whether the change to the operational store 10, specified in act 310, results in a modified operational store 10 schema. When the change specified in act 310 does not result in a modified operational store 10 schema, process 300 terminates. However, when it is determined that the change specified in act 310 results in a modified operational store 10 schema, the process 300 proceeds to act 330 wherein a determination is made as to whether the change to the operational store 10 is reportable to the data warehouse 30.

A change to the operational store 10 may be determined to be reportable to the data warehouse 30 in any suitable way, as the invention is not limited in this respect. In one embodiment, a change is considered to be reportable when the data impacted by the specified change is also stored in the data warehouse 30. For example, when a field of data added to the operational store 10 is to also be stored in the data warehouse 30, the change to the operational store 10 may be determined to be reportable. In contrast, when a field of data added to the operational store 10 need not be stored in the data warehouse 30, the change to the operational store 10 may be determined to be non-reportable.

When the change to the operational store 10 schema is deemed non-reportable, the process 300 terminates. However, when it is determined in act 330 that the change to the operational store 10 is reportable, the process 300 proceeds to act 340, wherein, the designer is queried regarding how the data warehouse 30 schema should be modified based on the operational store 10 schema change. The designer may be queried using any suitable user interface, as the invention is not limited in this respect. In act 350, the designer's response to the query issued in act 340 is received and specifies how the data warehouse 30 schema should be modified in response to the specified change in the operational store 10 schema. The process 300 then proceeds to act 360, wherein the information defining the manner in which the schema change in the operational store 10 impacts the schema of the data warehouse 30 is stored. This information can be stored in any suitable place and manner, as the invention is not limited in this respect. In the embodiment for use with the system of FIG. 2, the information can be stored in the metadata 12 using XML or any other suitable schema description language.

It should be appreciated that the embodiment described above for storing information defining the schema change to the data warehouse 30 in response to the schema change in the operational store 10 is only an illustration of a possible technique. A number of alternate techniques can be employed. For example, if all changes specified by the designer are operational store 10 schema changes, act 320 need not be performed to determine whether a change specified by the designer modifies the operational store 10 schema.

In accordance with another embodiment, changes in the operational store 10 schema may be automatically detected and appropriate changes in the data warehouse 30 schema may be automatically implemented. This may be done by any process and in any suitable way, as the invention is not limited in this respect. For example, such a process may be performed by the warehouse service 70 described in system 200 of FIG. 2.

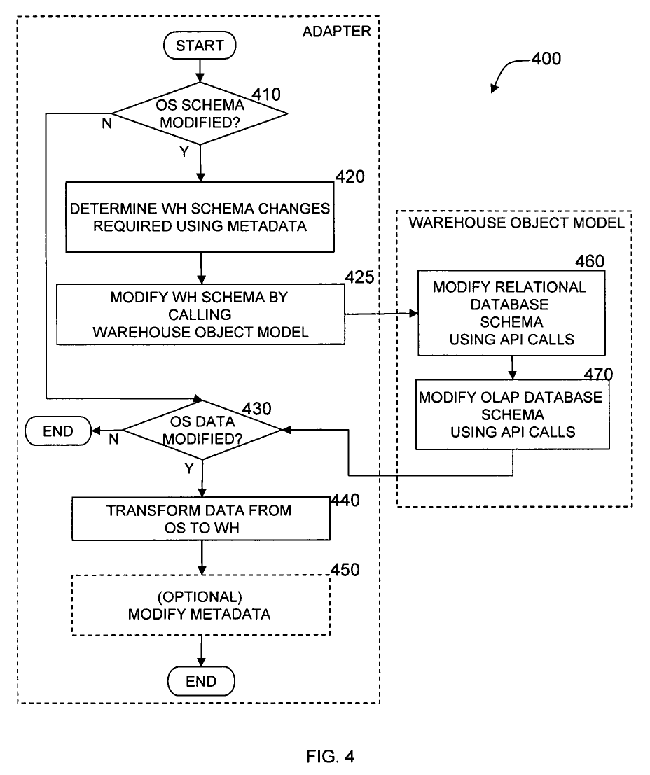

An exemplary illustration of such a process 400, to be implemented by the data warehouse service 70, is shown in FIG. 4, which illustrates various acts performed by the adapter 72 and the warehouse object model 74.

Initially, in act 410, it is determined whether the operational store 10 schema has been modified. The operational store 10 schema may change in response to administrative settings made by a user or administrator, or for any other suitable reason. The determination as to whether the operational store 10 schema has been modified may be determined in any suitable way, as the invention is not limited in this respect. For example, the determination may be based on date and time stamp information present in metadata 12, or using any other suitable technique.

In the example of the date and time stamp approach, any modification of the schema of the operational store 10 may result in modification of the metadata 12, including updating of a date and time stamp associated with entries relating to the modified schema of the operational store 10. Hence, an operational store 10 schema change may be detected when any operational store 10 schema data in metadata 12 possesses a date and time stamp that is more recent than the previous date and time the data warehouse 30 schema was updated. Of course, other detection techniques can be employed, as the invention is not limited in this respect.

When it is determined that the operational store 10 schema has been modified, the process 400 proceeds to act 420, wherein the desired changes to the data warehouse 30 schema may be determined based on information in the metadata 12, or in any other suitable way. For example, the metadata 12 may contain information relating to the data warehouse 30 schema change desired to reflect the detected operational store 10 schema change. This schema change information may have been entered in the metadata 12 using the process 300 illustrated in FIG. 3, or using any other suitable process.

In act 425, the data warehouse 30 schema may be modified by calling the warehouse object model 74 and passing the information regarding the desired data warehouse 30 schema change. Alternatively, the detected schema changes of the operational store 10 may be passed to the warehouse object model 74, and the warehouse object model may then access the metadata 12 to determine the desired data warehouse 30 schema change.

In process 400, the warehouse object model 74 then executes acts 460 and 470 to modify the schema of the data warehouse 30. In act 460, the schema of the relational database 40 of the data warehouse 30 is modified by calling one or more APIs (e.g., in the SQL language or another), where each API call may modify the schema of one or more tables in the relational database 40. Similarly, in act 470, the schema of the OLAP database 50 of the data warehouse 30 is modified by calling one or more APIs (e.g., in the SQL language or another), where each API call may modify the schema of one or more cubes in the relational database 40.

For example, in a case where a new field is added to the operational store 10, thereby modifying the schema of the operational store 10, in act 460, the schema of the relational database 40 of the data warehouse 30 is modified by calling one or more APIs (e.g.: in the SQL language or another), where each API call may add a new field to one or more tables in the relational database 40. Similarly, in act 470, the schema of the OLAP database 50 of the data warehouse 30 is modified by calling one or more APIs (e.g.: in the SQL language or another), where each API call may add a new dimension to one or more cubes in the relational database 40.

The process 400 then proceeds to act 430 where it is determined whether the operational store 10 data has been modified in any suitable way, as the invention is not limited in this respect. In one embodiment, a date and time stamp in the metadata 12 or the operational store 10 may indicate whether the operational store 10 data has been modified since a previous time when the data in the data warehouse 30 was updated. When it is determined that the operational store 10 data has not been modified, the process 400 terminates.

When it is determined that the operational store 10 data has been modified, the process 400 proceeds to act 440, wherein the modified data from the operational store 10 is transformed and loaded into the appropriate database entries in the data warehouse 30. For example, the modified data in the operational store 10 may be transformed and loaded into the appropriate database entries in the relational database 40 of the data warehouse 30. In optional act 450, the metadata 12 may be modified, possibly for purposes of recording any changes to the operational store 10 and/or data warehouse 30 or for any other suitable reason. For example, the data stored in the metadata 12 may include a previous name for a field, a reporting flag, or any other relevant information.

It should be appreciated that process 400, illustrated in FIG. 4, may be executed by the adapter 72 and the warehouse object model 74, illustrated in the embodiment of FIG. 2, but may also be executed, in part or whole, by any other suitable entity, as the invention is not limited in this respect.

Furthermore, the warehouse object model 74 may modify the data warehouse 30 schema based on a call from the adapter 72, as illustrated in FIG. 2. As mentioned above, the adapter 72 may determine the desired data warehouse 30 schema change based on the metadata 12 and pass the information along to the warehouse object model 74. In other embodiments, the warehouse object model 74 may access the metadata 12 directly to determine the desired data warehouse 30 schema change based on the operational store 10 schema change.

In some embodiments, process 400 may be used to automatically update the data warehouse 30 schema as a result of changes in the operational store 10 schema. In such embodiments, neither an administrator or designer need manually perform the acts necessary to detect changes in the operational store 10 schema and modify the data warehouse schema 30.

As should be appreciated from the foregoing, there are numerous aspects of the present invention described herein that can be used independently of one another, including the aspects that relate to automatically changing the schema of a data warehouse in response to changes in the schema of one or more associated operational stores, querying a designer to specify how a schema change in an operational store changes an associated data warehouse schema, utilizing an adapter to detect schema changes in an operational store, and calling a data warehouse object model to execute API calls (e.g., in the SQL or another language) to change the schema of the associated data warehouse.

However, it should also be appreciated that in some embodiments, all of the above-described features can be used together, or any combination or subset of the features described above can be employed together in a particular implementation, as the aspects of the present invention are not limited in this respect.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

It should be appreciated that the various methods outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code. In this respect, it should be appreciated that one embodiment of the invention is directed to a computer-readable medium or multiple computer-readable media (e.g., a computer memory, one or more floppy disks, compact disks, optical disks, magnetic tapes, etc.) encoded with one or more programs that, when executed, on one or more computers or other processors, perform methods that implement the various embodiments of the invention discussed above. The computer-readable medium or media can be transportable, such that the program or programs stored thereon can be loaded onto one or more different computers or other processors to implement various aspects of the present invention as discussed above.

It should be understood that the term “program” is used herein in a generic sense to refer to any type of computer code or set of instructions that can be employed to program a computer or other processor to implement various aspects of the present invention as discussed above. Additionally, it should be appreciated that according to one aspect of this embodiment, one or more computer programs that, when executed, perform methods of the present invention need not reside on a single computer or processor, but may be distributed in a modular fashion amongst a number of different computers or processors to implement various aspects of the present invention.

Various aspects of the present invention may be used alone, in combination, or in a variety of arrangements not specifically discussed in the embodiments described in the foregoing, and the aspects of the present invention described herein are not limited in their application to the details and arrangements of components set forth in the foregoing description or illustrated in the drawings. The aspects of the invention are capable of other embodiments and of being practiced or of being carried out in various ways. Various aspects of the present invention may be implemented in connection with any type of network, cluster or configuration. No limitations are placed on the network implementation.

Accordingly, the foregoing description and drawings are by way of example only.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalent thereof as well as additional items.

What is claimed:

1. A method for managing a system comprising at least one operational data store that stores an operational data set and a data warehouse that stores a warehouse data set that is associated with at least some of the data in the operational data set, each of the at least one operational data store and the data warehouse having a schema, the method comprising an act of, in response to a change being made to the schema of the at least one operational data store:
(A) automatically updating the schema of the data warehouse to reflect the change to the schema of the at least one operational data store.

2. The method of claim 1, further comprising an act of:
(B) automatically detecting that the schema of the at least one operational data store has changed;
and wherein the act (A) is performed in response to the automatic detection performed in the act (B).

3. The method of claim 1, wherein the act (A) comprises determining a manner in which the schema of the data warehouse should be updated to reflect the change to the schema of the at least one operational data store by referencing metadata that specifies the manner in which the schema of the data warehouse should be updated to reflect the change to the schema.

4. The method of claim 3, wherein the metadata that specifies the manner in which the schema of the data warehouse should be updated to reflect the change to the schema of the at least one operational data store is provided by a designer in response to a query.

5. The method of claim 2, wherein the act (B) comprises checking a time and date stamp associated with the schema of the at least one operational data store.

6. The method of claim 1, further comprising an act of:
(C) updating metadata associated with the schema of the data warehouse.

7. The method of claim 1, wherein the data warehouse comprises a relational database and an OLAP database.

8. The method of claim 1, wherein the change to the schema of the at least one operational data store comprises adding a field.

9. The method of claim 1, wherein the change to the schema of the at least one operational data store comprises deleting a field.

10. The method of claim 1, wherein the change to the schema of the at least one operational data store comprises renaming a name of a field.

11. A computer-readable medium having instructions encoded thereon, which instructions, when executed in a computer system perform a method for managing a system comprising at least one operational data store that stores an operational data set and a data warehouse that stores a warehouse data set that is associated with at least some of the data in the operational data set, each of the at least one operational data store and the data warehouse having a schema, the method comprising an act of, in response to a change being made to the schema of the at least one operational data store:
(A) automatically updating the schema of the data warehouse to reflect the change to the schema of the at least one operational data store.

12. The computer-readable medium of claim 11, further comprising an act of:
(B) automatically detecting that the schema of the at least one operational data store has changed;
and wherein the act (A) is performed in response to the automatic detection performed in the act (B).

13. The computer-readable medium of claim 11, wherein the act (A) comprises determining a manner in which the schema of the data warehouse should be updated to reflect the change to the schema of the at least one operational data store by referencing metadata that specifies the manner in which the schema of the data warehouse should be updated to reflect the change to the schema.

14. The computer-readable medium of claim 13, wherein the metadata that specifies the manner in which the schema of the data warehouse should be updated to reflect the change to the schema of the at least one operational data store is provided by a designer in response to a query.

15. The computer-readable medium of claim 12, wherein the act (B) comprises checking a time and date stamp associated with the schema of the at least one operational data store.

16. The computer-readable medium of claim 11, further comprising an act of:
(C) updating metadata associated with the schema of the data warehouse.

17. The computer-readable medium of claim 11, wherein the data warehouse comprises a relational database and an OLAP database.

18. At least one computer for managing a system, the system comprising at least one operational data store that stores an operational data set and a data warehouse that stores a warehouse data set that is associated with at least some of the data in the operational data set, each of the at least one operational data store and the data warehouse having a schema, the at least one computer comprising:
at least one processor programmed to, in response to a change being made to the schema of the at least one operational data store, automatically update the schema of the data warehouse to reflect the change to the schema of the at least one operational data store.

19. The at least one computer of claim 18, wherein the at least one processor is further programmed to automatically detect that the schema of the at least one operational data store has changed, and wherein the automatic update of the schema of the data warehouse to reflect the change to the schema of the at least one operational data store is performed in response to the automatic detection that the schema of the at least one operational data store has changed.

20. The at least one computer of claim 18, wherein the automatic update of the schema of the data warehouse to reflect the change to the schema of the at least one operational data store comprises determining a manner in which the schema of the data warehouse should be updated to reflect the change to the schema of the at least one operational data store by referencing metadata that specifies the manner in which the schema of the data warehouse should be updated to reflect the change to the schema.
